(19) United States
(12) Patent Application Publication
(10) Pub. No.: US 2006/0106809 A1
(43) Pub. Date: May 18, 2006

(54) Systems and methods for supporting accurate decision making

(76) Inventors: Boi Faltings, Preverenges (CH); Pearl Pu Faltings, Preverenges (CH)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 11/274,601

(22) Filed: Nov. 14, 2005

Related U.S. Application Data
(60) Provisional application No. 60/627,661, filed on Nov. 12, 2004.

(51) Int. Cl. G06F 17/30

(52) U.S. Cl. 707/10

(57) ABSTRACT

Various embodiments of the present invention include a comparison and tradeoff tool that is adapted for: (1) conducting an initial, computer-based search of options based on a set of two or more preferences specified by a user; (2) allowing a user to, based on the results of the initial search, (a) revise at least a first one of the set of preferences to specify that the first preference must be satisfied at an increased level in a subsequent search, and (b) revise at least a second one of the set of preferences to specify that it is acceptable for the second preference to either not be satisfied, or satisfied at a decreased level in the subsequent search; (3) conducting the subsequent search; and (4) displaying the results of the subsequent search to the user.

### CROSS-REFERENCE TO RELATED APPLICATIONS

This application claims priority from U.S. provisional patent application 60/627,661, filed on Nov. 12, 2004 and entitled “Interactive Tool for Supporting Accurate Decision Making”, and which is hereby incorporated herein by reference in its entirety.

### FIELD OF THE INVENTION

Various embodiments of the present invention comprise a computer implemented tool (e.g., a software-based tool) for increasing a decision maker's accuracy in choosing his or her most preferred option from a set of k options. These options are preferably distinct and are defined by a set of attributes. The k options can be the entire set of all available options or can be selected from a larger initial set of options.

### BACKGROUND OF THE INVENTION

In many situations (such as during the process of deciding which item of several different items to purchase) it is often desirable for a user to attempt to identify a “most preferred option” (e.g., the item that would best suit their current needs) from a set of k available options (e.g., all available items of the type of item at issue, or a subset of these items).

In many cases, k is a significant number, often ranging in the hundreds or even thousands. Finding the most preferred option out of k possibilities may require sifting through all of the options and trading off their pros and cons manually. This can be a very time consuming task. Alternatively, people can employ selective strategies that are less time consuming, but are known to achieve a much lower level of decision accuracy. Due to time and effort limitations, people often opt for selective decision strategies that identify a choice with little cognitive effort. This is the case of human decision making in the absence of a decision support tool as far as choosing the most preferred item is concerned. Various embodiments of the systems and methods described below address this situation and may help people to efficiently make more accurate decisions.

### SUMMARY OF THE INVENTION

A computer system for searching a first set of options according to various embodiments of the invention is adapted for executing the steps of: (A) obtaining a first set of one or more preferences from a user or another source, wherein: (1) each of the preferences specifies a desired characteristic, or an aspiration level, of a particular attribute and/or its degree of satisfaction, (2) the first set of one or more preferences comprises a first preference, the first preference specifying a desired characteristic of a first particular attribute, (3) the first set of one or more preferences comprises a second preference, the second preference specifying a desired characteristic of a second particular attribute; (B) identifying a second set of options based, at least in part, on the one or more preferences, each member of the second set of options also being a member of the first set of options; (C) conveying the second set of options to a user; and (D) after the step of conveying the second set of options to the user, receiving from the user, a set of tradeoff criteria comprising: (1) a first indication of a that the first particular preference and/or its degree of satisfaction must be improved in a subsequent search of options (e.g., a subsequent search of the first or second set of options); and (2) a second indication that the degree to which the second particular preference is satisfied can be decreased in the subsequent search of options; and (E) performing the subsequent search of options based, at least in part, on the tradeoff criteria.

Similarly, a method for searching a first set of options according to various embodiments of the invention also comprises steps (A)-(E), above. In addition, various embodiments of the invention include a computer readable medium comprising computer-executable instructions for executing steps (A)-(E), above.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a Comparison and Tradeoff System according to one embodiment of the invention.

FIG. 2 is a block diagram of a Comparison and Tradeoff Server according to one embodiment of the invention.

FIG. 3 is a flow chart depicting the logical flow of various embodiments of the comparison and tradeoff tool.

FIG. 4 is an exemplary preference model entry window.

FIG. 5 in an exemplary display of several options that correspond well to the current preferences.

FIG. 6 in an exemplary graphical user interface for use in specifying tradeoff criteria.

FIG. 7 is an exemplary display of several options that correspond well to a current set of user preferences (as modified by the tradeoff criteria specified in FIG. 6).

FIG. 8 is an exemplary display of options grouped according to the combinations of preferences they satisfy.

FIG. 9 is an exemplary display of different popular tradeoff criteria with respect to a reference option, which is shown at the top of the display. For each set of tradeoff criteria, the tool shows several options that fit the criteria.

### DETAILED DESCRIPTION OF VARIOUS EMBODIMENTS OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements.

As will be appreciated by one skilled in the relevant field, the present invention may be embodied, for example, as a method, a data processing system, or a computer program product. Accordingly, the present invention may take the form, for example, of an entirely hardware embodiment, an entirely software embodiment, or an embodiment having both software and hardware components. Furthermore, the present invention may take the form of a computer program product on a computer-readable storage medium having computer-readable program code embodied in the storage medium. Any suitable computer-readable storage medium may be utilized including hard disks, CD-ROMs, optical storage devices, or magnetic storage devices.

The present invention is described below with reference to block diagrams and/or flowchart illustrations of methods, apparatuses (e.g., systems) and computer program products according to various embodiments of the invention. It will be understood that each block of the flowchart illustrations and/or each step described in the text, and/or combinations thereof can be implemented by computer program instructions. These computer program instructions may be loaded onto a general purpose computer, special purpose computer, or other programmable data processing apparatus to produce a machine to implement the functions described herein.

These computer program instructions may also be stored in a computer-readable memory that can direct a computer or other programmable data processing apparatus to function in a particular manner, such that the instructions stored in the computer-readable memory produce an article of manufacture including instructions for implementing the functions specified herein. The computer program instructions may also be loaded onto a computer or other programmable data processing apparatus to cause a series of operational steps to be performed on the computer or other programmable apparatus to produce a computer implemented process. In such an embodiment of the invention, the instructions that are executed on the computer or other programmable apparatus may serve to implement the functions specified herein.

Accordingly, blocks of the block diagrams and flowchart illustrations and the text of this patent application support systems and methods for performing the specified functions, as well as computer readable media storing computer-executable instructions for performing the specified functions. It will also be understood that the various processes described herein can be implemented by special purpose hardware-based computer systems that perform the specified functions or steps, or by combinations of computer hardware and computer instructions.

In one embodiment of the invention, the various system-implemented steps described within this application are implemented by a computer processor within a computer system. In a particular embodiment of the invention, this computer processor is coupled to a memory.

System Architecture

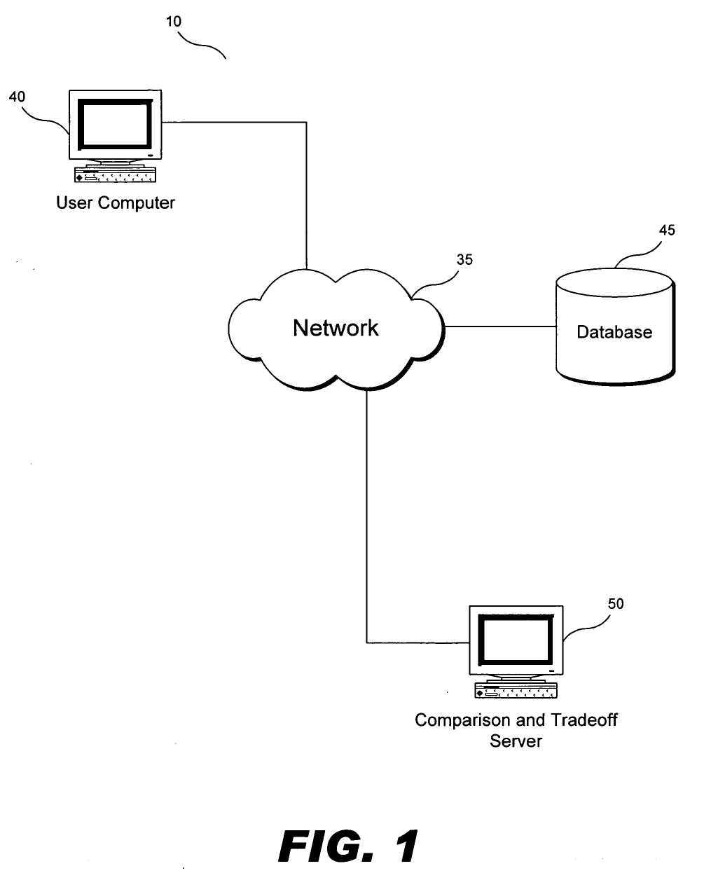

FIG. 1 shows a block diagram of a Comparison and Tradeoff System 10 according to one embodiment of the present invention. As may be understood from this figure, this exemplary Comparison and Tradeoff System 10 includes a user computer 40, a database 45, a Comparison and Tradeoff Server 50, and one or more communications networks 35 for facilitating communication between the user computer 40 and the Comparison and Tradeoff Server 50. These one or more communications networks 35 may include any of a variety of types of networks such as a public switch telephone network (PSTN), the Internet, a private intranet, or any other type of suitable network. In one embodiment of the invention shown in FIG. 1, the communications network 35 comprises a global communications network such as the Internet.

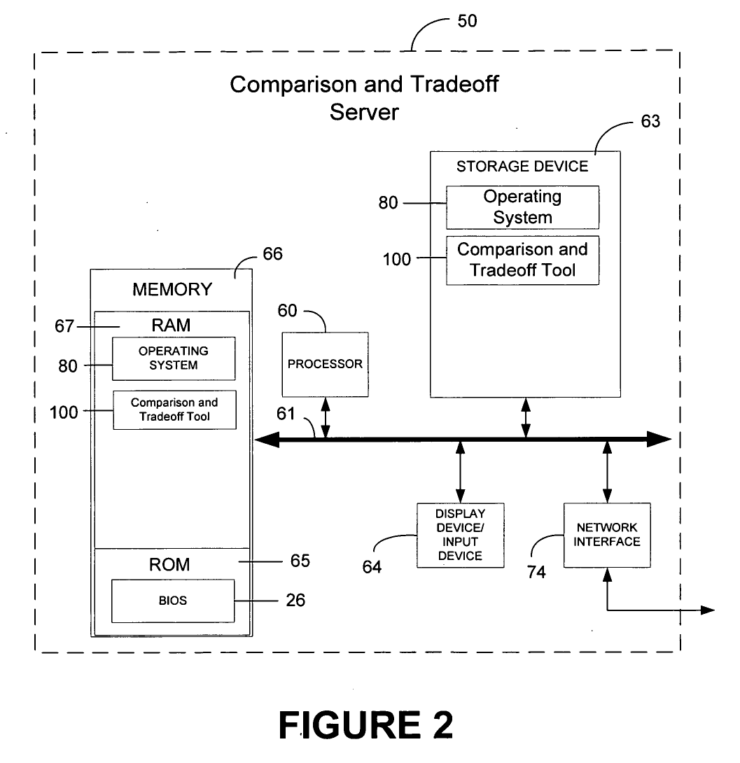

FIG. 2 is a block diagram of an exemplary embodiment of the Comparison and Tradeoff Server 50 of FIG. 1. In this embodiment, the Comparison and Tradeoff Server 50 includes a processor 60 that communicates with other elements within the Comparison and Tradeoff Server 50 via a system interface or bus 61. Also included in the Comparison and Tradeoff Server 50 is a display device/input device 64 for receiving and displaying data. This display device/input device 64 may be, for example, a keyboard or pointing device that is used in combination with a monitor. The Comparison and Tradeoff Server 50 further includes memory 66, which preferably includes both read only memory (ROM) 65 and random access memory (RAM) 67. The Comparison and Tradeoff Server's ROM 65 is used to store a basic input/output system 68 (BIOS) that contains the basic routines that help to transfer information between elements within the Comparison and Tradeoff Server 50.

In addition, the Comparison and Tradeoff Server 50 includes one or more storage devices 63, such as a hard disk drive, a floppy disk drive, a CD Rom drive, or optical disk drive, for storing information on one or more types of computer-readable media, such as hard disks, removable magnetic disks, or CD-ROM disks. As will be understood by one of ordinary skill in this field, each of these storage devices 63 is connected to the system bus 61 via an appropriate interface. The storage devices 63 and their associated computer-readable media provide nonvolatile storage for the Comparison and Tradeoff Server 50.

It should be understood that the computer-readable media described above may include any other suitable type of computer-readable media known in the art. Such media include, for example, magnetic cassettes, flash memory cards, digital video disks, and Bernoulli cartridges.

A number of program modules may be stored by the various storage devices and within the server's RAM 67. Such program modules include an operating system 80, and a Comparison and Tradeoff Tool Module 100 (also referred to herein as a “Comparison and Tradeoff Tool”). The Comparison and Tradeoff Tool 100 controls certain aspects of the operation of the Comparison and Tradeoff Server 50 with the assistance of the processor 60 and an operating system 80.

The exemplary Comparison and Tradeoff Server 50 also includes a network interface 74 for interfacing and communicating with other elements of a computer network. It will be appreciated by one of ordinary skill in this field that one or more of the Comparison and Tradeoff Server 50 components may be located geographically remotely from other Comparison and Tradeoff Server 50 components. Furthermore, one or more of the server's components may be combined, and additional components for performing functions described herein may be included in the Comparison and Tradeoff Server 50.

Contribution of the Comparison and Tradeoff Tool

A comparison and tradeoff tool according to one embodiment of the invention is an augmented element of a preference-based search engine that is adapted to automate the in-depth examination and tradeoff analysis for the user. In such embodiments, the tool is a software-based decision support tool which employs compensatory decision strategies when processing critical tradeoff information of the attribute values of all k options. In a preferred embodiment, with this tool, users are able to achieve increased accuracy (e.g., over 90% accuracy) in making their decisions while expending only a modest level of effort.

A detailed description of how various embodiments of this tool work is given in a later section. Here is a brief explanation: after the k options are displayed successively or simultaneously (e.g., in response to a user performing an initial search), the tool allows a user to select the displayed option which appears to be most attractive to her. This option may be referred to as the “current best option,” or the “reference option.”

For various reasons, the user's choice accuracy at the moment is often low. That is, the current best option may not quite be the user's target choice, partly due to preference uncertainties on the part of the user. Various embodiments of the comparison and tradeoff tool (CTT) play the role of improving the user's accuracy in selecting an appropriate option from a plurality of options by making the user more certain about the user's preferences and more importantly, by helping the user fine-tune their relative priorities among these various preference goals. In certain embodiments, the tool achieves this, at least in part, by letting the user compare the current best option (the “reference option”) with other similar options in order to identify an option that better satisfies the user's preferences.

Various embodiments of the CTT may also allow users to compare options among each other without specifying a reference option. To guide such comparisons, users may name both: (1) the preferences that they want to revise and/or whose degree of satisfaction they want to improve; and/or (2) the preferences whose degree of satisfaction they are willing to compromise. This information ({improved preferences}, {compromised preferences}), along with (optionally) a selected reference option, is called the tradeoff criteria (or critiques). Based on these tradeoff criteria, the CTT identifies a revised set of suitable options.

After comparing the initial selection with the tradeoff alternatives, the user may improve her accuracy in selecting a particular option. For example, consider a tool for selecting suitable student lodging. We use the notation (500 dollars, 25 square meters, 10 minutes) to describe an apartment whose rental price is 500 dollars per month, whose total floor space is 25 square meters, and which is located about 10 minutes by foot from the university where the decision maker is a graduate student. In one embodiment, a user would first be presented with a listing of k different apartments (which would be the “options” in this case). This presentation of options may occur, for example, in response to the user performing an initial search based on one or more preferences, such as that the surface should be more than 25 square meters. Alternatively, the initial listing of k different apartments may include all available apartments.

Suppose a user selects from the k options an apartment with the attributes 500 dollars, 25 square meters, and 10 minutes. The user can now use the CTT to look for something cheaper, and indicate this as a revision of the preference on price to a lower value. Furthermore, the user can specify, for example, that he or she is willing to compromise on the size and distance of the apartment. In response to receiving an indication that the user is willing to compromise on the size and distance of the apartment, the CTT will use the stated ({price}, {size, distance}) tradeoff criteria to find suitable options that provide tradeoff alternatives. For example, one alternative option found by the tool may be an apartment having the following parameters: (450 dollars, 20 square meters, 18 minutes). At that moment, the user can decide if the initially selected option was best or if one of the cheaper options (e.g., the 450 dollar, 20 square meter, 18 minute option) is better, depending on how she values price versus size and distance. In various embodiments, the CTT provides an automatic tool for facilitating the process of manually scanning all of the outcomes and trading off the gains in some attributes with the losses in others.

In the following sections, we describe in further detail how various embodiments of the CTT works and how it can be implemented and integrated in preference-based search engines for decision-support systems such as product search and configuration.

Description of Various Embodiments of the Comparison and Tradeoff Tool

One goal of certain embodiments of the CTT is to help users choose the most preferred option from a set of k possible alternative options. The set of alternative options may be collected from one or several databases, but may also be dynamically generated, for example by a search, configuration, scheduling, planning or other optimization tool. We particularly address the case where the set of k alternative options is relatively large so that it is inconvenient or impossible for the decision maker to compare the alternative options manually. In various embodiments, each alternative option is modeled by a particular set of attributes (e.g., that are assigned with wide-ranging values). Attributes can describe features of the options, or properties that are dependent on a combination of features. However, certain attribute values may be unknown or undefined for some of the options.

A comparison and tradeoff tool (CTT) according to various embodiments of the invention facilitates guiding the user through a comparison and tradeoff analysis process that improves decision accuracy. In various embodiments, the CTT allows the user to compare options with the goal of finding the one that represents the best tradeoff among the user's different preferences.

In various embodiments, the interaction between a user and the CTT can be characterized by five different steps, some of which may be carried out multiple times during a particular options selection process:
1. A set of preferences is established.
2. The CTT identifies a subset of the options, taking into account the set of preferences, and displays some or all of the options in this set to the user.
3. The user may choose one of the options in this subset as the target choice, or as a reference option for formulating tradeoff criteria.
4. The user can formulate a set of tradeoff criteria or modify the set of preferences.
5. The CTT identifies a new set of options, taking into account the tradeoff criteria and the set of preferences.

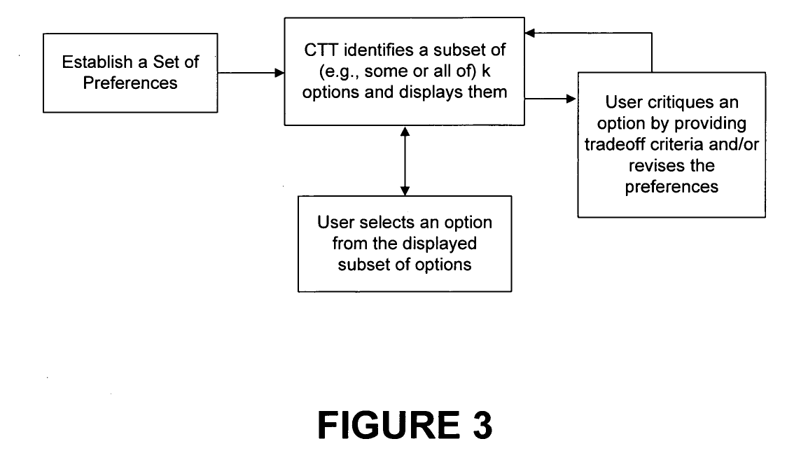

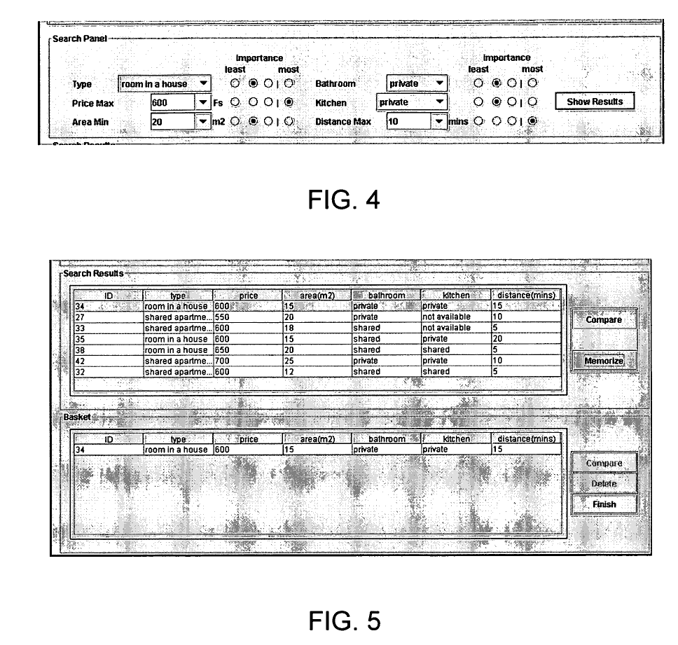

An exemplary logical connection between these steps in the CTT is shown in FIG. 3. In the first step, a preference model is established. Preferences describe desirable values of attributes and/or combinations of attributes. Each preference may be used to establish a partial order of the options where it is applicable such that some are better aligned with the desires of the user for that particular preference than others.

Each preference can take a variety of forms. In various embodiments, a preference can simply describe a desirable value of an attribute, such as “I prefer a private kitchen,” and thus define the ordering of options (e.g., options that included a private kitchen would be listed higher than those without a private kitchen). In various embodiments, it is also possible to add thresholds to preferences to help define an aspiration level for a particular attribute. For example, the user can state that the area of an apartment should be at least 50 square meters. In various embodiments, one or more thresholds can be established by selecting an example option and indicating that one or more (and, in certain embodiments, all) particular preference thresholds are satisfied by the example option. Finally, in a somewhat complex form, the CTT may allow users to define a preference as a function of attributes or combinations of attributes.

In various embodiments of the invention, one or more preferences can be also combined. For example, a user may state, “I prefer an apartment with a private kitchen and an area of at least 50 square meters.” With a more complex preference combination, the user can select some of these preferences to be active or inactive, or specify their relative importance, for example by numbers indicating the relative weights to be assigned to one or more of the preferences. In various embodiments, preferences may also be combined in various ways to establish a ranking of the options according to the model.

In one embodiment, the first functional step of the preference-based search tool is to elicit and establish a preference model for a given user. The set of preferences can be established from various sources. In some embodiments, some or all of the preferences can be established from a database that contains suitable preferences for a group of users or a specific user. In various embodiments, some or all of the preferences can be established by explicit specification from the user—for example, by explicitly asking the user to state a set of preferences using formal or natural language. Such a specification can be more or less detailed, ranging from a simple selection of standardized preferences to a very detailed specification of the preferred options.

In various embodiments, preferences may be obtained by having users choose an example option and having the attributes of this option define the desired characteristics and/or aspiration level for each preference. (In various embodiments, the CTT is adapted to automatically set up one or more of these threshold values in response to the user selecting a particular option as an example option.) Preferences can also be implicitly inferred from a program that is adapted to learn the user's preferences by observing the behavior of the user and/or other users. This behavior may include, for example, the past purchasing behavior of the user or other users. Additionally, in various embodiments, the CTT may also take into account actions or preference models of other users. In some embodiments, some or all of the preferences may also be established by carrying over the preferences from a previous interaction with the CTT (e.g., that involved searching the same or a different set of options.)

In the second step, the CTT identifies a set of options that are of interest to the user given the currently established set of preferences. In some embodiments, some or all of these options are chosen to be those that rank highest according to the user's current set of preferences. As will be understood to one skilled in the relevant field, any appropriate ranking mechanism may be used to rank the options. In various embodiments, when ranking the options, the ranking mechanism takes into account the stated preferences and arranges the options in a partial or total order based upon the user's specified preferences. For example, in various embodiments, for each option to be ranked, the system assigns each of the user's specified preferences a number indicating the extent to which that preference satisfies the user's specified preferences (e.g., in certain embodiments, higher numbers indicate that an attribute of a particular option satisfies the user's criteria for a particular preference to a greater extent, and lower numbers indicate that an attribute of a particular option satisfies the user's criteria for a particular preference to a lesser extent). In various embodiments, for each option to be ranked: (1) each of the user's specified preferences is multiplied by a weighting factor indicating the relative importance of that preference to the user; and (2) the weighted values of the user's specified preferences are added together to obtain a combined number such that a greater number indicates a higher preference. In alternative embodiments, the CTT establishes an importance ordering among preferences by first ordering the options according to the higher priority preference, and applies the lower-priority preference only within options that are equivalent with respect to the higher-priority preference. As a further alternative, options can be ranked according to the number of preferences that are satisfied to some minimum degree. Different schemes can also be combined; for example in various embodiments the CTT may identify different priority groups of preferences and apply the weighted sum within each group, but use the importance ordering between the groups. Many such possibilities have been described in the literature on preference optimization and can be applied in this context.

Examples of appropriate ranking mechanisms for use with various embodiments of the present invention include lexicographical ordering, weighted added sum, equal weight strategy, and CP-nets. For configurable options, examples of ranking mechanisms include, for example, weighted CSP, fuzzy CSP, and other forms of optimization techniques.

When stated preferences are in conflict, such as when a user wants a large apartment and has entered a rather tight budget, the CTT may be configured to resolve this issue by generating partially satisfied outcomes. For example, in various embodiments, the CTT will show options that satisfy either the size or the budget preference, but not both. In various embodiments, this approach requires less effort from the user than systems that simply indicate that no solution has been found or those that require the user to explicitly change preference values without contextual knowledge.

In some embodiments, some or all of these options are chosen to best educate the user about the range of available options. In particular embodiments, this may be achieved, for example, by modifying the ranking mechanism to take into account diversity of solutions. In some embodiments, the various displayed options can be chosen using strategies based on the user's specified set of preferences, as described in “Designing Example-Critiquing Interaction. In Proceedings of the International Conference on Intelligent User Interface (IUI-2004)”, Faltings, B., Pu, P., Torrens, M. and Viappiani,P, ACM Press, pages 22-29, Funchal, Madeira, Portugal, January 2004, which is hereby incorporated herein by reference.

The options thus determined are then displayed to the user. In various embodiments, this display takes into account the capabilities of the available display device and may make use of various graphical or multimedia facilities to better describe the options. The display may also use visualization and visual structuring techniques to give the user a better overview of what options are available and how they compare.

For example, in one embodiment the CTT may use an explanation interface that categorizes the set of options by comparing the degree to which the options satisfy certain preferences relative to a specified reference, or “current best,” option. For example, if the user is searching different notebook computers for a particular notebook computer that best satisfies certain preferences, the CTT may display both: (1) a first category of notebook computers that are cheaper but heavier than a reference option (e.g., a particular notebook computer selected by the user as the “current best” option), and (2) a second category that includes notebooks that are lighter but more expensive than the reference option. In various embodiments, each category indicates a tradeoff direction that the user might want to take in order to achieve his or her final decision goal.

In the third step, the CTT provides the user with the option to select one or more of the displayed set of options. In some embodiments, the CTT may allow a user to indicate that the selected option may be used to define tradeoff criteria for a subsequent tradeoff step. In some embodiments, the CTT may further allow a user to indicate that the selected option is the final result of the use of the CTT (e.g., the user may indicate that they wish to purchase the identified option).

In the fourth step, the user can provide a critique of the displayed options by providing tradeoff criteria, modifying the user's current set of preferences, or both. A problem associated with prior art tools is that there are often too many ways to improve the satisfaction of a given preference or combination of preferences, differing in what other preferences are compromised. This may result in a large set of options satisfying the tradeoff criteria. Users may not agree with the system-proposed compromises and, accordingly, displaying this set of tradeoff alternatives may be highly confusing for the users. Various embodiments of the proposed comparison and tradeoff tool circumvent this problem by letting the user indicate explicitly which compromises should be made, thus significantly narrowing the choice and greatly increasing the observed performance.

In various embodiments, the CTT allows the user to specify not only a combination of preferences whose aspiration level, desired characteristics and/or degree of satisfaction should ideally be improved in an upcoming search and ranking of options, but also a combination of preferences whose degree of satisfaction is allowed to get worse in the search and ranking of options. This may increase the accuracy of the search.

In various embodiments, tradeoff criteria may include an indication of what preferences should be improved upon, and what preferences can be compromised in order to obtain the improvement. In some embodiments, this may translate into a modification of the user's current set of preferences. For example, in response to receiving a set of tradeoff criteria from the user, the CTT may modify the user's current set of preferences so that the specified importance of preferences that are to be improved are increased, and so that the importance of preferences to be compromised are decreased.

In various embodiments, the CTT allows a user to define one or more tradeoff criteria by selecting a reference option that may be used to define a set of tradeoff alternatives. In various embodiments, this reference option is understood to be part of the tradeoff criteria.

In particular embodiments, once the user: (1) has specified which preferences should be improved upon and which preferences can be compromised in order to obtain the improvement; and (2) has selected a reference option, the CTT modifies the user's current set of preferences to indicate: (1) that the preferences to be improved must be better than those of the reference option (e.g. satisfy a better aspiration level or be satisfied to a higher degree); (2) that the preferences to be compromised may be worse, equal to, or better than those of the reference option; and (3) that all remaining preferences must be at least as good those of the selected reference option. In embodiments where no reference option has been selected, these remaining preferences may be maintained at their previous weight. Thus, the process identifies three sets of preferences: an improve set, a maintain set, and a compromise set. In various embodiments, together, these sets are the tradeoff criteria. In certain embodiments, the maintain set can be left implicit as the set of attributes not mentioned in either the improve or compromise sets. In alternative embodiments, the tradeoff criteria may also be indicated, for example, using a menu, using question answering, marking attributes directly in the display of the options, or through a dialog in formal or natural language.

To simplify the user's task in specifying suitable tradeoff criteria, certain embodiments of the tool may keep a record of tradeoff criteria that have been used earlier by the same or other users and suggest such tradeoff criteria, or tradeoff criteria derived from such information, to the user for selection. For example, the tool may be adapted to provide a selection of tradeoff criteria that have been most frequently expressed by the user or a community of users in the past. Also, in various embodiments, the tool is adapted to propose such criteria to the user along with an indication of what options could be found that satisfy them.

In the fifth step, the CTT again identifies a subset of the options, taking into account the user's current set of preferences and any tradeoff criteria that have been identified by the user. In certain embodiments, this step is similar to step 2, except that the method is configured to also take into account the tradeoff criteria.

In various embodiments, when the tradeoff criteria include a reference option, the tool searches for options that improve the preferences and/or the degree of satisfaction of the preferences in the improve set to the largest possible extent, while allowing any value for the preferences that can be compromised to an arbitrary degree, and satisfying the preferences in the maintain set to at least the same degree as in the reference option. In other embodiments, the CTT is adapted to select any option that improves on preferences in the improve set while maintaining the degree of satisfaction for as many preferences in the maintain set as possible. In further embodiments, the CTT treats the preferences in the compromise set as less important and uses them (e.g., only uses them) to differentiate between options that are considered equally good according to the other preferences.

In yet another embodiment, the tool sets the weight of the compromised attribute to a small value or even 0, meaning that they have no or little importance, increases the weights of the preferences that should be improved, and then searches for options that are ranked highest according to the weighted sum of the preferences. A drawback of this simpler approach may be that there may be no guarantee that the preferences whose satisfaction should improve do indeed improve. However, this technique can also apply when no reference option has been identified as part of the tradeoff criteria. Many combinations and variations of such strategies can be imagined by those skilled in the art and may be applied depending on the nature of the options to be searched.

When the CTT generates this set of options, the same considerations as in step 2 may apply. In particular, when preferences are in conflict, various embodiments the tool may identify options that satisfy the combination of preferences to the best possible degree according to various ranking schemes including those that have been described above in regard to step 2. Conflicts can also exist between tradeoff criteria. In this case, partial solutions may be ranked, for example, either based on: (1) the set of all preferences and the tradeoff criteria together—including the degree to which the tradeoff criteria are satisfied; (2) the number of tradeoff criteria that can be satisfied; or (3) other rankings based on the tradeoff criteria.

In displaying the options thus identified, the same considerations as described for step 2 may apply. In addition, whenever displaying options it is useful to carefully consider the various relevant design issues. For example, in one embodiment: 1) there is preferably a certain diversity in the options to enhance the ability of the user to recognize tradeoff opportunities; 2) there is preferably a sufficient number of optimal solutions to allow the user to select the most preferred option available in spite of any inaccuracies in the model; and 3) there is preferably a limit on how many solutions can be shown—which can help to avoid overwhelming the user with too many options.

In various embodiments, the comparison and tradeoff tool automates the in-depth examination and tradeoff analysis of comparable options after an earlier step (e.g., that may not be part of the CTT) has identified a reduced set (from 1 up to all) of options from a larger space of options. For example, in various embodiments, such an earlier step could be carried out by a search engine that retains a certain set of results. In some embodiments, such an earlier step could be decision support tool that generates a set of solution options based on user requirements. Other possibilities where such sets could be constructed can be easily imagined by those skilled in the art in light of this disclosure. The reduced set can be stored in a fixed database or generated dynamically as requested by the CTT. In various embodiments, the step that identifies the set of options may also take into account preferences that have been identified through the CTT tool, for example by using a common interface for their definition or by using preferences identified in an earlier run of the CTT.

Example Illustrating the Use of the CTT

The general behavior of methods according to various embodiments of the invention is best understood using an example. This is an embodiment of our method in a search tool that finds the most suitable lodging for university students. Each alternative is characterized by 6 attributes: the type of lodging, its price, the surface area, the type of bathroom, the type of kitchen, and the distance to the university. In this example, there is a predefined ordering for each attribute, such as the bigger the surface area, the better the apartment, etc. A user specifies a preference by specifying the relative degree to which this ordering matters to him or her and/or an aspiration level for the particular attribute, either explicitly or by selecting an example option. In various embodiments, a preference model comprises a set of preferences over all attributes. The user can specify and revise the preference model through a suitable graphical interface such as the graphical user interface shown in FIG. 3. In this tool, for each of the preferences, the user can also specify a weight value that indicates the importance of the preference. In this example, the user has previously established a set of preferences. In the second step, the tool displays a set of options that could possibly be good choices according to the preference model. In this example, the system lists 7 candidate apartments as shown in FIG. 5.

This embodiment of the CTT allows the user to compare tradeoff alternatives with respect to a particular option. In this example, the user has selected one option, No. 34 (shown highlighted), as a reference option for the tradeoff process. In the tradeoff process, this option will set the appropriate aspired level and/or its relative degree of satisfaction for the various preferences.

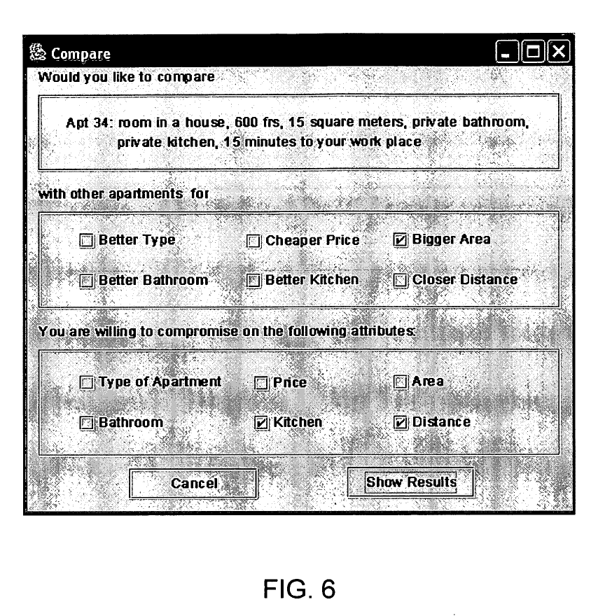

In addition, the user can then select or be guided to select a comparison and tradeoff interface as shown in FIG. 6. In this window, the user can indicate the preferences whose degree of satisfaction and/or aspired levels he or she wants to improve, and the preferences whose degree of satisfaction can be compromised.

In this example, the user has chosen Apartment 34 as a reference option, and chooses to improve the area of the lodging, while being ready to compromise on the type of kitchen and distance to the university.

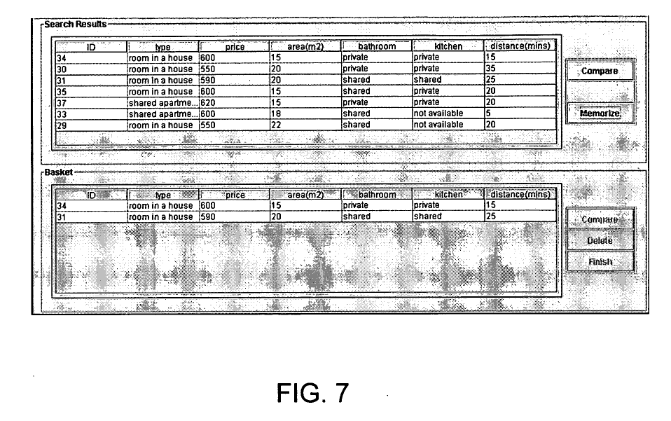

The tool then searches the available options and provides a set of possibilities that best fit the tradeoff criteria that have been entered. The tool then displays the resulting options to the user, as shown in FIG. 7. In various embodiments, the user can make any of these options the starting point of a new tradeoff process or the user may be satisfied with one or more of the options found and exit the process. In this example, apartment 31 seems interesting to this user, since it is around the same price as the reference option but 5 square meters bigger, although it is 10 minutes farther from the University by foot and it has a shared bathroom. In various embodiments, the system does not resolve tradeoffs for the user, but provides enough information for him or her to understand the decision context. The final choice is preferably left to the user.

The method has been illustrated above within the context of an apartment search. However, it should be understood that the method may be applied in the same way to other identifying other services or products (e.g., products that can be modeled by attributes), such as the following non-exhaustive list of examples:

travel itineraries and hotels,

consumer products such as computers, cameras, cars, etc.

financial and investment products

insurance products

information and information services

Furthermore, the method can be applied in decision-support systems, such as for scheduling personnel usage or for selecting the best option among a range of possibilities.

Implementing Different Variants of the Comparison and Tradeoff Functionality

According to one embodiment, in a multi-attribute preference-based search, outcomes are modeled using a set of attributes. Attributes can be divided, for example, into two different types, component and feature. A component attribute is, for example, a physical aspect of a choice (e.g., the screen size of a PC), while a feature attribute is, for example, an abstract concept such as the suitability of a product for outdoor use (good, bad). Formally, an attribute is modeled by a variable that can take values in a fixed domain. An option is described by a combination of attribute values.

People make decisions by considering a set of criteria that involve these attributes. For example, a criterion when facing a certain decision could be how tiring a trip is likely to be or how well the trip's schedule fits the tasks to be accomplished. Each criterion is a function of one or several attributes. Many criteria are simple functions of a single attribute. For instance, whether an arrival time is early enough for an 18:00 h meeting or whether the airline fits the user's preference are simple criteria based on one attribute. Others can be more complex. For example, how tiring a trip is may depend on the total travel time, the departure and arrival times, the number of stops, etc. Preferences based on one criterion or a set of criteria determine how the final outcome space may be ordered using one or a combination of several ranking mechanisms.

Because preferences are naturally defined on criteria, changes in preference models arise as addition, removal or change of importance of threshold for some criteria. In particular, in various embodiments, the tradeoff criteria needed in the CTT can be formulated in this way.

Preferences can be specified in a large variety of ways. In a very general form, one can explicitly represent the way they order the values of the associated criteria. However, while there are techniques for computing rankings based on such preferences, this is may not be particularly efficient for computer processing. It is often useful for preferences to be functions from values of the criteria to a numerical value that expresses the degree to which the preference is satisfied. For example, a preference for an arrival time before 18:00 could be expressed by a function that maps every arrival time before 18:00 into 1 and every time after 18:00 into 0. In another version, the preference could also express a certain tolerance and map every arrival time before 17:45 into 1, times between 17:45 and 18:30 into a value between 0 and 1 according to a decreasing function, and all times after 18:30 into 0. It is possible to make the numerical value correspond in some form to the amount of money that a user is willing to pay for satisfying the preference to this degree; in this case it is called a utility. Examples of known ranking strategies include forming the weighted sum of preference functions, where the best ranked option would be the one that scores highest on this rank. Another example is to maximize the number of preferences that are satisfied at least to some degree. Another example is to establish an importance ordering and use less important preferences only to order options that are considered equivalent according to the more important preferences.

The different strategies can also be combined in various ways, and, in light of this disclosure, those skilled in the art will be able to select an appropriate formalism and combination strategy for the application of the comparison and tradeoff tool at hand.

In many cases, many users will share the same preference for certain criteria. For example, it can usually be assumed that most users would prefer options with a lower price. Such preferences can be set in the tool by default. In other cases, preferences may be partially predictable and involve certain thresholds. In general, for many preferences the tool can provide templates that can be instantiated through interaction with a user. Further details and examples of such techniques can be found in the open literature, for example in “Designing Example-Critiquing Interaction. In Proceedings of the International Conference on Intelligent User Interface (IUI-2004)”, Faltings, B., Pu, P., Torrens, M. and Viappiani,P, ACM Press, pages 22-29, Funchal, Madeira, Portugal, January 2004, which is hereby incorporated herein by reference.

In certain embodiments, in the second and fifth functional steps of the preference-based search, the CTT computes a set of options that better satisfy the set of preferences and tradeoff criteria. The system does this by conducting a search to identify those options that: (1) exceed the specified criteria for preferences that the user has indicated should be improved; and (2) satisfy or exceed the specified criteria for preferences that the user has indicated should be maintained. In the course of this search, the system preferably ignores the preferences that, according to the user, can be compromised.

Alternatively, the system may select the options that are best according to a combination of preferences, where the preferences that should be improved have a greater weight, those that should be maintained an equal weight, and those that can be compromised a lower weight than in the previous preference model. This method can also be used when no reference option has been identified as part of the tradeoff criteria. Variants can be designed for the particular application of the CTT based, for example, on the numerous ranking strategies for the preferences as outlined earlier.

There is a wide variety of methods for determining the options with respect to a set of preferences or tradeoff criteria. A first class of methods translates the ranking into constraints on the options that would satisfy them. For example, for a set of tradeoff criteria they could identify the options that improve on the improve set of preferences while not decreasing satisfaction of the compromise set. Determining the set of satisfactory options may then be carried out by filtering a list of items, and more efficiently using various indexing and database schemes that are well-known in the art. However, such methods may not generate any options to display when there are no options that satisfy the constraints.

Another set of methods identify suitable options by searching for the options that rank highest on different ranking schemes for preferences. This amounts to maximizing a combination of the degree of satisfaction of the preferences. This technique is most often carried out using either the branch-and-bound principle (e.g., tree search, constraint programming) or the mathematical programming principle (e.g., linear programming, dynamic programming, integer programming). Both are well-known to those skilled in the art and are described in numerous publications.

When the set of options is dynamically generated through process other than the CTT, such as a search tool, a configuration tool, or a decision-support tool, the other process' ranking mechanism may be incorporated into this tool so that it is not necessary to generate the entire set of options.

In certain cases, it may also be useful to display not only options that rank highly according to the current preferences, but also options that are chosen to educate the user about the range of possible options. For example, the CTT may be configured to show options that satisfy certain preferences or combinations of preferences to the best or least possible degree. Similarly, in various embodiments, the CTT may be configured to select options that have a high chance of becoming optimal if additional preferences are added to the current set of preferences.

In certain embodiments, when displaying the set of options to the user, the CTT can use various techniques to make it easier for the user to understand the results that are displayed. For example, similar options can be grouped into common categories.

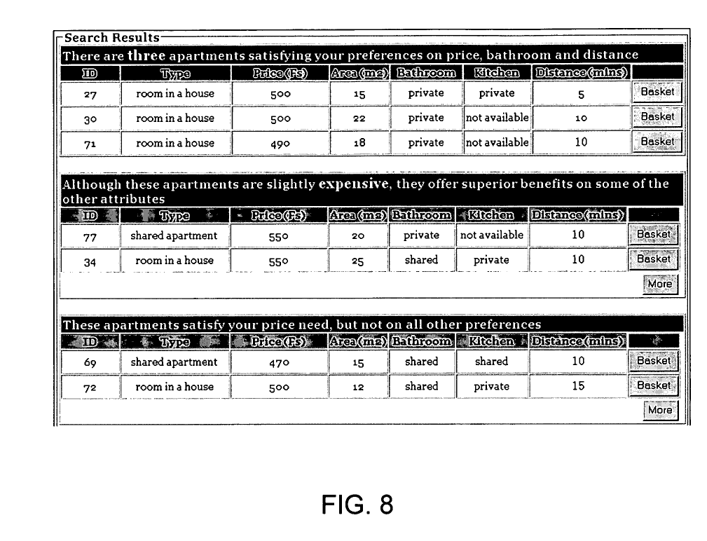

FIG. 8 shows an example of such a display. The CTT may also be configured to display only a limited number of options in each category. In addition, in various embodiments, the CTT may be configured to display the features of certain options side by side to allow easy comparison. In further embodiments, the CTT may plot the options in a multi-dimensional display, where each dimension corresponds to a different feature.

In various embodiments, the comparison and tradeoff tool provides the fourth functional step of the preference-based search tool. In particular, it lets the user define the preferences that should be improved, those that are to be maintained, and those that can be compromised. This may be done by giving the user the option of selecting each of the existing preferences to be in one or the other set. It also may involve the user by asking him or her to state additional preferences that should be satisfied. This interaction can be done, for example, through a suitable graphical interface or through other means of human-computer dialogues.

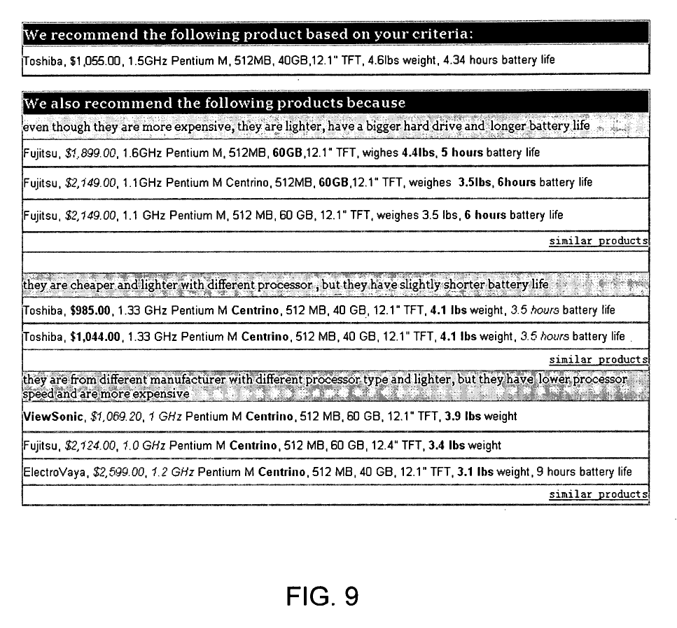

In various embodiments, the system determines, for example, from records of past interactions with the user or other users, what tradeoff criteria are commonly desirable in similar searches. The tool then allows the user to choose one or more of these tradeoff criteria for use in the user's current search. The system may further support this choice by indicating how many options would satisfy the tradeoff criteria, or even show some of the options that satisfy the tradeoff criteria. These indications can be computed using the methods otherwise employed in step 5 of the tool. FIG. 9 shows an example of such a display.

Conclusion

Many modifications and other embodiments of the invention will come to mind to one skilled in the art to which this invention pertains having the benefit of the teachings presented in the foregoing descriptions and the associated drawings. For example, while many aspects of the invention were described above as being implemented specifically in the context of a CTT, it should be understood that such aspects may be implemented within the context of other types of systems and/or software tools. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for searching a first set of options, said computer system being adapted to execute the steps of:
(A) obtaining a first set of one or more preferences from a user or another source, wherein:
(1) each of the first set of one or more preferences specifies a desired characteristic of a particular attribute,
(2) the first set of one or more preferences comprises a first preference, the first preference specifying a desired characteristic of a first particular attribute,
(3) the first set of one or more preferences comprises a second preference, the second preference specifying a desired characteristic of a second particular attribute,
(B) identifying a second set of options based, at least in part, on the one or more preferences, each member of the second set of options also being a member of the first set of options;
(C) conveying the second set of options to a user; and
(D) after the step of conveying the second set of options to the user, receiving from the user, a set of tradeoff criteria comprising:
(1) a first indication of an improvement that the first preference must undergo in a subsequent search of options; and
(2) a second indication that the degree to which the second preference is satisfied can be decreased in the subsequent search of options; and
(E) performing the subsequent search of the first set of options based, at least in part, on the tradeoff criteria.

2. The computer system of claim 1, wherein said improvement of said first preference in Step (D) (1) comprises a modification of said desired characteristic of said first particular attribute.

3. The computer system of claim 1, wherein said first preference comprises an aspiration level of the underlying attribute and said improvement of said first preference in Step (D)(1) comprises an improvement in this aspiration level.

4. The computer system of claim 1, wherein said improvement of said first preference in Step (D)(1) comprises an increase in the degree to which said first preference must be satisfied.

5. The computer system of claim 1, wherein said subsequent search of options is a search of said first set of options.

6. The computer system of claim 1, wherein said subsequent search of options is a search of said second set of options.

7. The computer system of claim 1, wherein the computer system is configured for: in Step (D), allowing the user to specify the first indication independently of the second indication.

8. The computer system of claim 1, wherein the computer system is configured for: in Step (D), allowing the user to specify the first indication and said second indication regardless of whether the set of tradeoff criteria would be satisfied by one or more options within the first set.

9. The computer system of claim 1, wherein the step of obtaining the first set of one or more preferences from a user or another source comprises obtaining at least one of the first set of one or more preferences from the user.

10. The computer system of claim 1, wherein the step of obtaining the first set of one or more preferences from a user or another source comprises accessing at least one of the first set of one or more preferences from memory.

11. The computer system of claim 1, wherein the computer system is further configured for determining the first set of one or more preferences based upon past behavior of the user or other users.

12. The computer system of claim 1, wherein the set of tradeoff criteria further comprises an indication of a particular option that provides a first reference value to be used by the computer system in determining, for one or more options from the first set of options, whether the degree to which the first preference has been satisfied has increased.

13. The computer system of claim 1, wherein the second set of options comprises at least one option from the first set of options that is selected to best satisfy the first set of preferences.

14. The computer system of claim 1, wherein the first set of options has been identified based at least in part on said first set of one or more preferences.

15. A computer system for searching a first set of options, said computer system being adapted to execute the steps of:
(A) obtaining a first set of one or more preferences from a user or another source, wherein:
(1) each of the first set of one or more preferences specifies a desired characteristic of a particular attribute,
(2) the first set of one or more preferences comprises a first preference, the first preference specifying a desired characteristic of a first particular attribute,
(3) the first set of one or more preferences comprises a second preference, the second preference specifying a desired characteristic of a second particular attribute,
(B) identifying a second set of options based, at least in part, on the one or more preferences, each member of the second set of options also being a member of the first set of options;
(C) conveying the second set of options to a user; and
(D) performing a search to identify a third set of one or more options that improve said first preference while allowing a decrease in said degree of satisfaction of said second preference; and
(E) displaying said third set to said user.

16. The computer system of claim 15, where said first preference comprises an aspiration level of the underlying attribute and said improvement is an increase in said aspiration level.

17. The computer system of claim 15, where said improvement of said first preference is to change the desired characteristic of the underlying attribute.

18. The computer system of claim 15, where said improvement of said first preference is to increase the degree to which said first preference is satisfied.

19. The computer system of claim 15, wherein said first and second preferences are chosen independently of their degree of satisfaction by one or more options within said second set of options.

20. The computer system of claim 15, wherein
said computer system is further adapted to execute a step of receiving, from said user, an indication of a reference option; and
said third set is selected, at least in part, based on said reference option.
